(19) United States
(12) Patent Application Publication
(10) Pub. No.: US 2025/0005081 A1
(43) Pub. Date: Jan. 2, 2025

(54) UNIVERSAL SEARCH INDEXER FOR ENTERPRISE WEBSITES AND CLOUD ACCESSIBLE WEBSITES

(71) Applicant: Microsoft Technology Licensing, LLC, Redmond, WA (US)

(72) Inventors: Chandrasekhar Subramanya AKKIRAJU VENKATA, Woodinville, WA (US); Rakesh CHAKARI MALLAREPPA, Bothell, WA (US); Rohit SHARMA, Issaquah, WA (US); Joel RAMOS-MUNOZ, Redmond, WA (US); Bo WANG, Kirkland, WA (US); Kailun QIAN, Kirkland, WA (US); Kishore SERALATHAN, Bothell, WA (US); Anick SAHA, Bellevue, WA (US); Luana Martins DOS SANTOS, São Paulo (BR); Venkata Surya Lakshmi Jogi Raju VEGIRAJU, Redmond, WA (US)

(73) Assignee: Microsoft Technology Licensing, LLC, Redmond, WA (US)

(21) Appl. No.: 18/344,192

(22) Filed: Jun. 29, 2023

(51) Int. Cl. G06F 16/951; G06F 16/953

(52) U.S. Cl. CPC G06F 16/951; G06F 16/953

(57) ABSTRACT

Systems and methods are provided for implementing a universal search indexer for enterprise and cloud accessible websites. A universal search indexer, using a crawling agent, crawls a target website and/or web documents in the target website, which includes a plurality of webpages including at least one of one or more static webpages or one or more dynamic webpages. The universal search indexer extracts website content and/or web documents as the target website is being crawled, and ingests the extracted website content and/or web documents within a data store, by indexing the extracted website content and/or web documents in a search index of the data store. The extracted website content and/or web documents are indexed to be searchable and refinable using a search engine, the extracted website content and/or web documents being retrievable via the search engine.

### BACKGROUND

Websites include either cloud-accessible websites or enterprise websites behind firewalls. Although web searches can extend into cloud-accessible websites, web searches of enterprise websites are typically blocked by the firewalls behind which the enterprise websites are located. Search utilities are typically unable to allow web searches of both cloud-accessible websites and enterprise websites behind firewalls. It is with respect to this general technical environment to which aspects of the present disclosure are directed. In addition, although relatively specific problems have been discussed, it should be understood that the examples should not be limited to solving the specific problems identified in the background.

### SUMMARY

This summary is provided to introduce a selection of concepts in a simplified form that are further described below in the detailed description section. This summary is not intended to identify key features or essential features of the claimed subject matter, nor is it intended as an aid in determining the scope of the claimed subject matter.

The currently disclosed technology, among other things, provides for a universal search indexer for enterprise websites that are behind enterprise firewalls and cloud accessible web sites, which can be static or dynamic (or client side rendered). A universal search indexer, using a crawling agent, crawls a target website, which includes a plurality of webpages including at least one of one or more static webpages or one or more dynamic webpages. In some examples, the crawling agent may also be used to crawl web documents that are contained within, embedded in, or linked by one or more webpages among the plurality of webpages of the target website. The universal search indexer extracts website content and/or web documents as the target website is being crawled, and ingests the extracted website content and/or web documents within a data store, by indexing the extracted website content and/or web documents in a search index of the data store. The extracted website content and/or web documents are indexed to be searchable and refinable using a search engine, the extracted website content and/or web documents being retrievable via the search engine.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing a universal search indexer for enterprise and cloud accessible websites.

FIG. 2 depicts a block diagram illustrating an example connector architecture for implementing a universal search indexer for enterprise and cloud accessible websites.

FIGS. 3A-3D depict diagrams illustrating various example user experiences (“UXs”) for search utilities of host apps when implementing a universal search indexer for enterprise and cloud accessible websites and/or search engine results page (“SERP”) functionality.

FIGS. 4A-4C depict an example method for implementing a universal search indexer for enterprise and cloud accessible websites.

FIG. 5 depicts a block diagram illustrating example physical components of a computing device with which aspects of the technology may be practiced.

### DETAILED DESCRIPTION OF CERTAIN EMBODIMENTS

A search utility that is used to query, and that presents results, for website content and/or web documents in a target website typically does not allow for searching enterprise websites that are behind firewalls.

A simple universal configuration is provided that enables enterprise administrators (“admins”) to configure, e.g., using an admin UX, websites that participate in a work place search or other searches. In examples, a universal search indexer implements a solution that provides features including search indexing of static and dynamic websites, searching of cloud-accessible websites as well as enterprise websites behind firewalls, implementing different authentication configurations, supporting meta tags for custom properties, implementing expression-based enrichment for generating new custom searchable properties, implementing incremental synchronization support for sitemap-enable crawls, and/or crawling of websites and web documents as part of a single crawl function.

Search results from all connected external enterprise data sources are displayed as rich adaptive cards in user interfaces (“UIs”) of SERPs. The universal search indexer enables, via admin UXs, configuration of data sources to crawl their data repositories and enable users to search for content in the search utility. Search results in the UIs include enterprise website content that are extracted and ingested from enterprise websites behind firewalls.

The SERP ecosystem provides a more consistent and immersive experience for users by providing a solution to connect first party and third party data to the users' enterprise search experience. Furthermore, the universal search indexer enables authenticated users to use SERPs to quickly visualize results and other relevant content from enterprise data sources, while surfacing or displaying consistent results across other search canvases. The solution lets administrators to configure connections to ingest data from data sources like enterprise websites, data lake storage, comma-separated value (“CSV”) data sources, web-based collaborative platforms, and/or file sharing platforms. Although an out-of-the-box display format for results is provided, the admin UX enables customization of the display layout for user enterprise search results that will be shown in the SERP UIS.

Various modifications and additions can be made to the embodiments discussed without departing from the scope of the disclosed techniques. For example, while the embodiments described above refer to particular features, the scope of the disclosed techniques also includes embodiments having different combination of features and embodiments that do not include all of the above-described features.

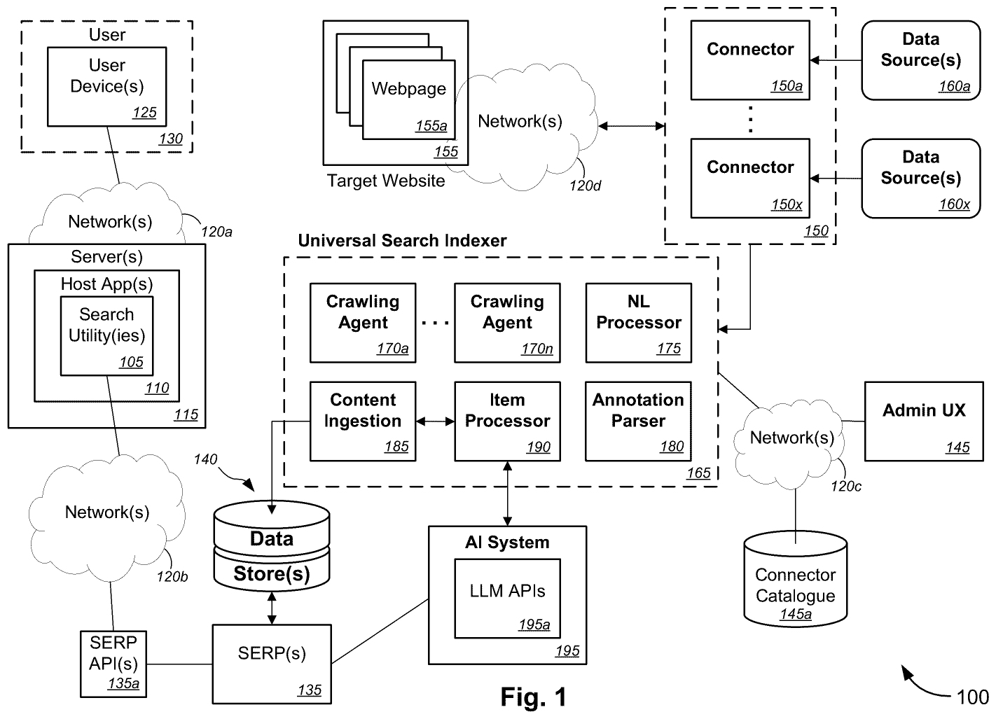

We now turn to the embodiments as illustrated by the drawings. FIGS. 1-5 illustrate some of the features of a method, system, and apparatus for implementing search utility functionality, and, more particularly, to methods, systems, and apparatuses for implementing a universal search indexer for enterprise and cloud accessible websites, as referred to above. The methods, systems, and apparatuses illustrated by FIGS. 1-5 refer to examples of different embodiments that include various components and steps, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

FIG. 1 depicts an example system 100 for implementing a universal search indexer for enterprise and cloud accessible websites. System 100 includes one or more search utilities 105 that are associated with corresponding one or more host apps 110. The host apps 110 may each be hosted or operated on a server(s) 115. The search utilities 105, the host apps 110, and/or servers 115 may communicatively couple, via one or more networks 120a, with one or more user devices 125 associated with a user 130. The search utilities 105, the host apps 110, and/or servers 115 may also communicatively couple, via one or more networks 120b, with a SERP system 135, via SERP application programming interface (“API”) 135a. System 100 further includes one or more data stores 140, an administrator (“admin”) UX 145, and/or a connector catalogue 145a.

In some examples, system 100 further includes one or more connector frameworks 150, including connectors 150a-150x (collectively, “connectors 150”). System 100 further includes a target website 155, which includes a plurality of webpages 155a-155y (collectively, “webpages 155”) including at least one of one or more static webpages or one or more dynamic webpages. A static webpage or website, as used herein, refers to a webpage or a website that includes a fixed number of pre-built files stored on a web server, and that includes web pages to look exactly the same to anyone who requests it. A dynamic webpage or website, as used herein, refers to a webpage or a website that are built “on-the-fly” (or in response to a search query), and that includes web pages to look different depending on one or more factors, including user location, local time, settings, preferences, and/or user actions taken on the website. In examples, system 100 further includes one or more data sources 160a-160x (collectively, “data sources 160”), which correspond to the connectors 150a-150x. System 100 further includes universal search indexer 165, including one or more crawling agents 170a-170n (collectively, “crawling agents 170”), natural language (“NL”) processor 175, annotation parser 180, content ingestion system 185, and item processor 190. System 100 further includes AI system 195, which includes LLM APIs 195a. In examples, Admin UX 145 communicatively couples to connector catalogue 145a and connector framework(s) 150 via network(s) 120c. In examples, connector framework(s) 150 communicatively couples to target website 155 and/or webpages 155a-155y via network(s) 120d. In some cases, networks 120a, 120b, 120c, and 120d may be the same network(s) or same group of networks. In other cases, networks 120a, 120b, 120c, and 120d may be separate networks or separate groups of networks. Networks 120a, 120b, 120c, and 120d (collectively, “network(s) 120”) may each include at least one of a distributed computing network, such as the Internet, a private network, a commercial network, or a cloud network, and/or the like.

In some instances, the one or more user devices 125 may each include one of a desktop computer, a laptop computer, a tablet computer, a smart phone, a mobile phone, or any suitable device capable of communicating with network(s) 120a or with servers or other network devices within network(s) 120a. In some examples, the user devices 125 may each include any suitable device capable of communicating with at least one of the search utilities 105, the host apps 110, and/or the servers 115, and/or the like, via a communications interface. The communications interface may include an app-based portal (e.g., app UI hosted on server(s) 115) or a web-based portal, an API, a server, an app, or any other suitable communications interface (not shown), over network(s) 120a. In some cases, user 130 may include an individual, a group of individuals, or agent(s), representative(s), owner(s), and/or stakeholder(s), or the like, of any suitable entity. The entity may include a private company, a group of private companies, a public company, a group of public companies, an institution, a group of institutions, an association, a group of associations, a governmental agency, or a group of governmental agencies.

In examples, the one or more search utilities 105 are configured to receive user search queries from user device(s) 125 and to relay the user search queries to the SERP system 135 via SERP API 135a. In some examples, although not shown in FIG. 1, the SERP system 135 includes a router, a router state history, one or more query builders, one or more query executors, a query cache, and a component renderer. Host app(s) 110 each hosts corresponding search utilities 105 and configures the router of the SERP system 135 by sending configuration data to the router. The configuration data defines search verticals, which are focused views of content types that are displayed in a UI of the search utility. The router provides the user search query and location information to a query builder(s), the location information describing a view of SERP 135 that is derived from a current uniform resource locator (“URL”) corresponding to the SERP 135 and that is a representation of a location to which a user can navigate. The router state history stores current states of the router. The query builder(s) constructs a query request corresponding to the user search query, based on the provided user search query and location information. A query executor(s) executes the query request, in some cases, by retrieving query results from the query cache, while in other cases, by executing the query request to produce the query results. The component renderer renders one or more UX components within the SERP based on the query results.

In examples, the data store(s) 140 stores website content and web documents or other data for the website content. In some examples, the web documents each includes one of a word processor document file, a spreadsheet document file, a presentation document file, a drawing document file, a printable format document file, an email data file, a calendar data file, a database item document file, a web document file, an image file, or a video file. Admin UX 145 provides an administrator with options and tools for accessing connector catalogue 145a to identify and/or to select one or more connectors 150 and 150a-150x for connecting with data sources 160a-160x. Universal search indexer 165 is configured to crawl, extract, ingest, and index website content and/or documents of the website content. In examples, universal search indexer 165 is configured to crawl, using crawling agent 170a-170n, webpages 155a-155y of a target website 155 via network(s) 120d and connector(s) 150 and/or 150a-150x, in response to receiving a request to index target website 155. In some examples, universal search indexer 165 is further configured to determine, using NL processor 175, whether the search query has connector intent (i.e., a search query including an intent to select at least one connector for connecting with corresponding at least one data store). Based on a determination that the search query has connector intent, the NL processor 175 generates consolidated search results including matching website content from two or more different data sources via corresponding two or more connectors. The consolidated search results are then presented within the UI of the SERP, based on one of common configurations of display layout within the UI for the two or more connectors or configurations for display layout within the UI based on a hierarchy for the two or more connectors. In some examples, universal search indexer 165 is configured to identify, using annotation parser 180, which portions of the extracted website content from a webpage 155 among the plurality of webpages of the target website 155 correspond to which portions of the webpage 155 from which they are extracted, the portions of the webpage including a header portion, a footer portion, and a body. The annotation parser 180 may annotate each portion of the extracted website content with annotations indicating one of the header portion, the footer portion, or the body, based on the identification.

Universal search indexer 165 is configured to ingest, using the content ingestion system 185, the extracted website content and/or the web documents or data of extracted website content and to process, using the item processor 190, the extracted website content and/or web documents or data to produce extracted data, which may subsequently be ingested by content ingestion system 185. Item processor 190 may also be used to send the extracted website content and/or web documents or data to AI system 195. In some cases, the crawling, extracting, and ingestion processes may be performed within universal search indexer 165 via one of tenant specific model or platform subscription managed resource, the former being focused on tenant systems while the latter being focused on a platform-wide system covering multiple tenant systems.

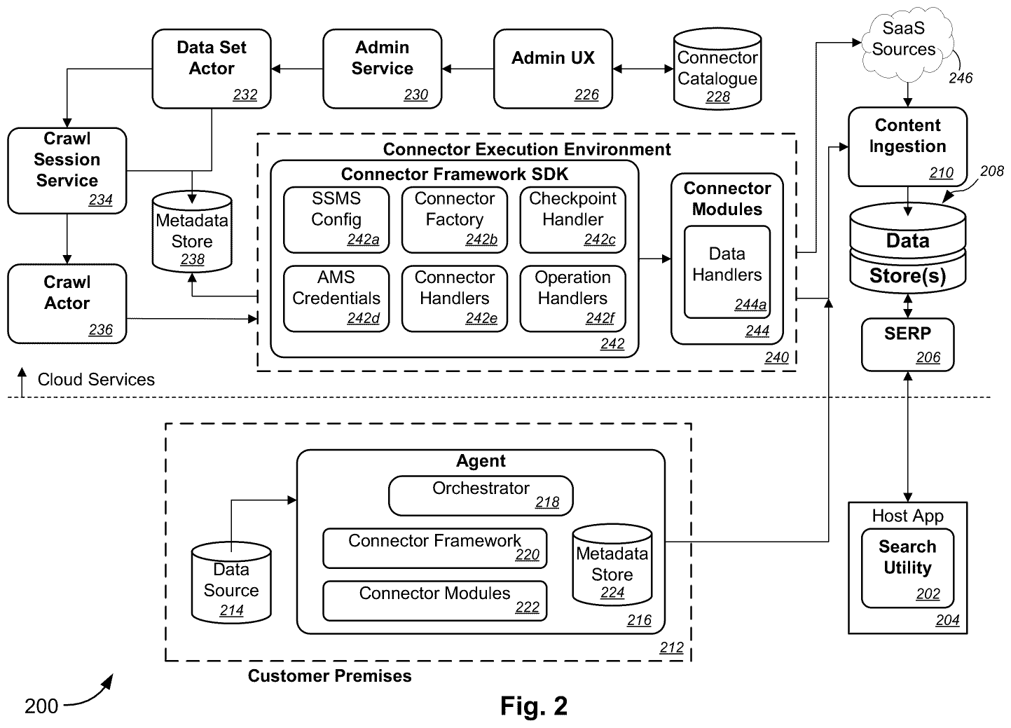

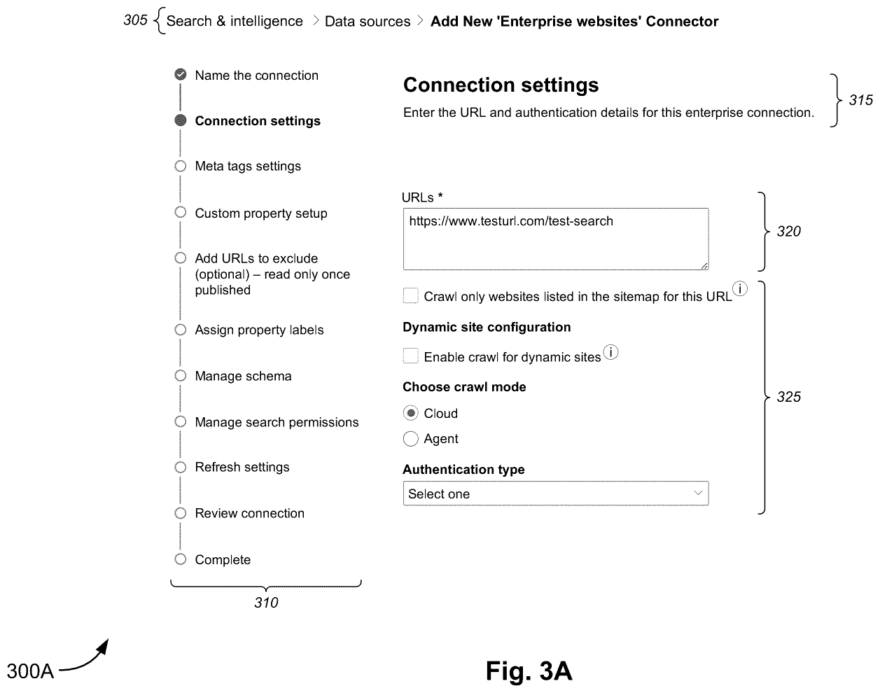

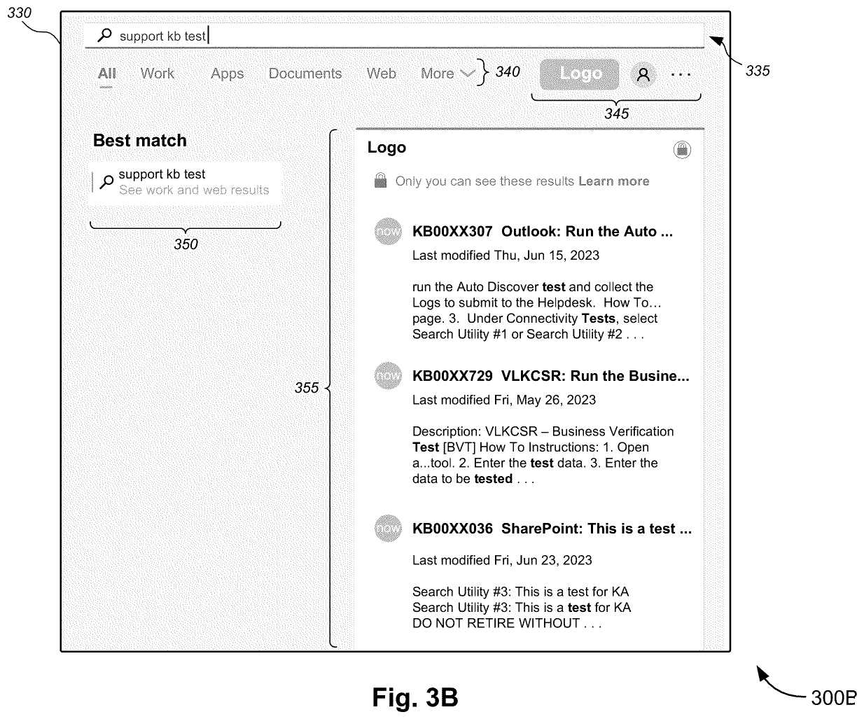

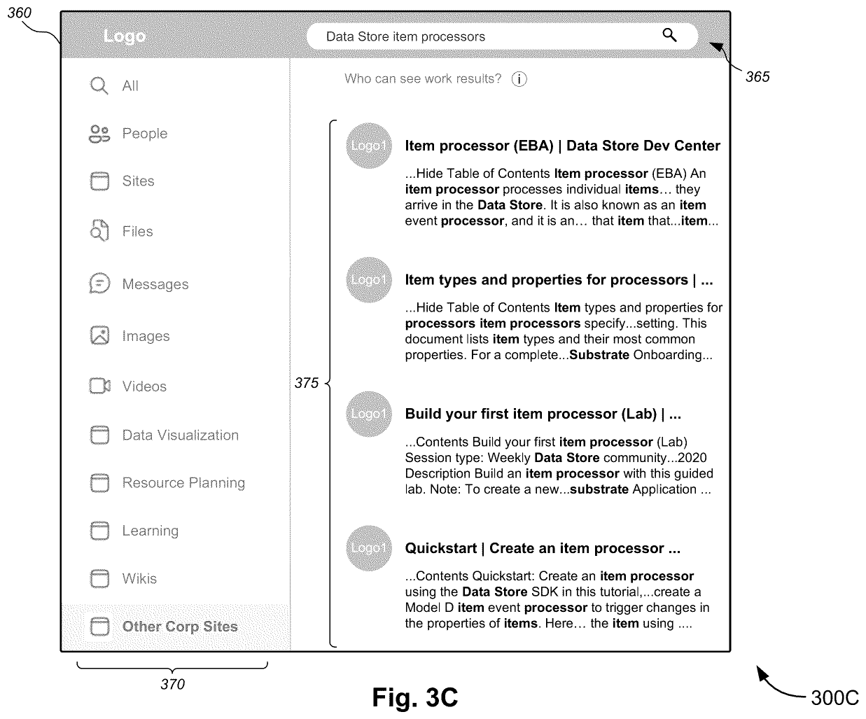

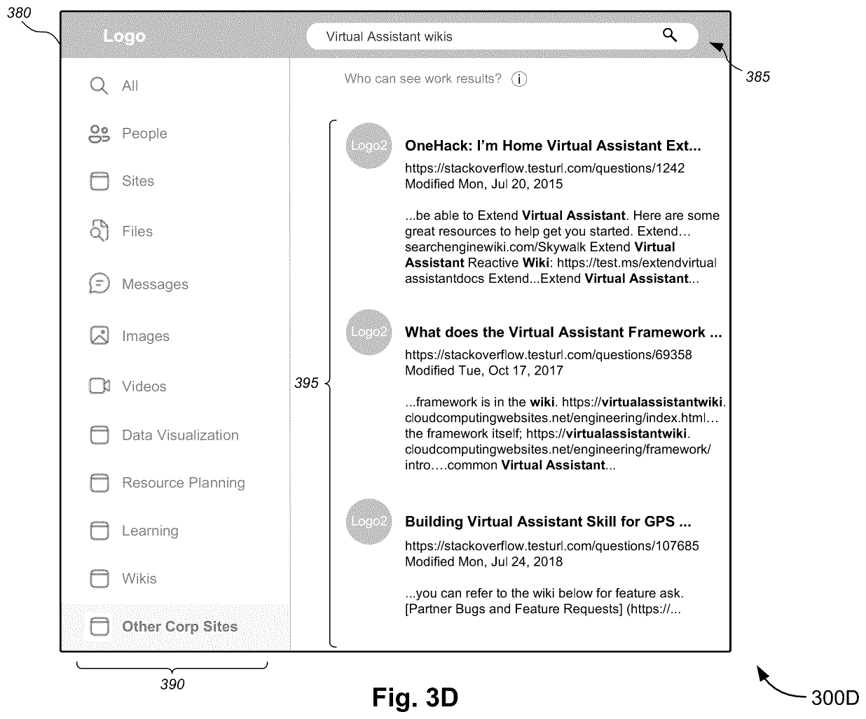

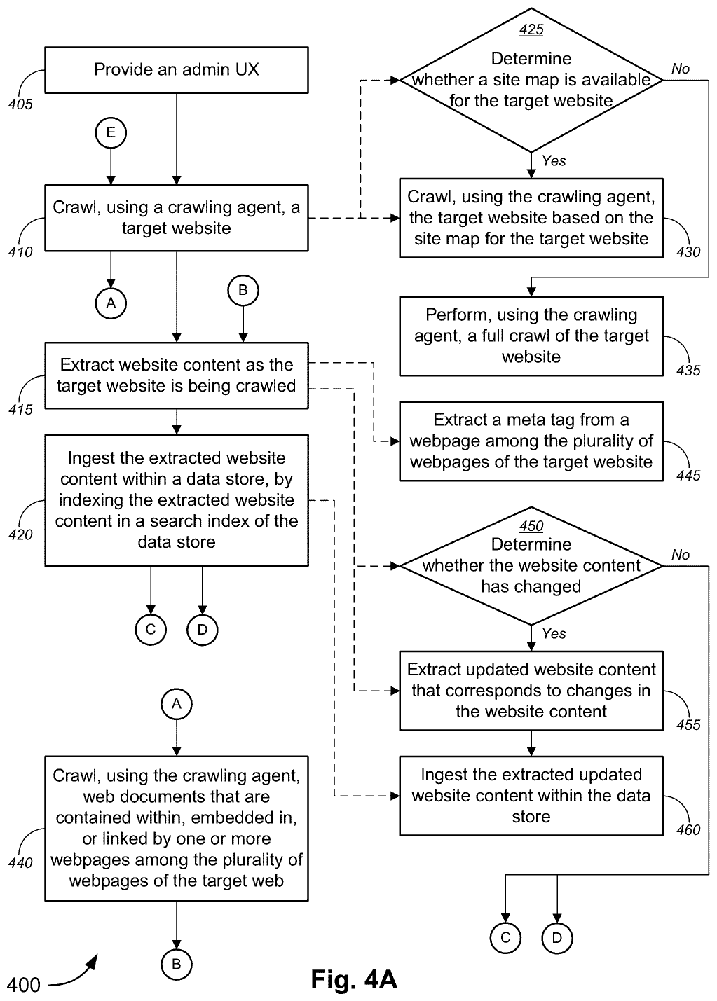

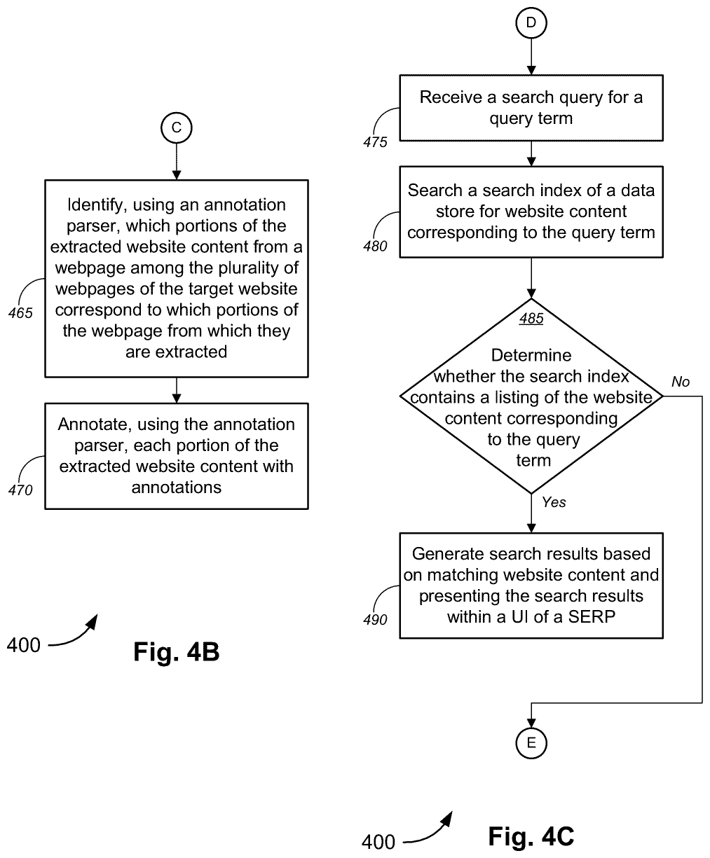

In operation, universal search indexer 165, crawling agent(s) 170a-170n, NL processor 175, annotation parser 180, content ingestion system 185, item processor 190, and/or AI system 195 (collectively, “computing system”) may perform methods for implementing universal search indexing for enterprise and cloud accessible websites, as described in detail with respect to FIGS. 2-4C. For example, the following functionalities may be applied with respect to the operations of system 100 of FIG. 1. FIG. 2 as described below is directed to an example connector architecture 200 for implementing a universal search indexer for enterprise and cloud accessible websites. The server(s) 115 and/or the SERP system 115 may perform generating, presenting, and/or implementing the example UXs 300A, 300B, 300C, and 300D of FIGS. 3A, 3B, 3C, and 3D, which, in conjunction with the computing system, present admin a UX 300A (FIG. 3A) and present search results based on website content matching queried terms in the search results display field. FIGS. 4A-4C as described below are directed to the method for implementing a universal search indexer for enterprise and cloud accessible websites.

FIG. 2 depicts a block diagram illustrating an example connector architecture 200 for implementing a universal search indexer for enterprise and cloud accessible websites. In some embodiments, search utility 202, host app 204, SERP 206, data store(s) 208, content ingestion system 210, data source 214, agent system 216, admin UX 226, connector catalogue 228, connector execution environment or connector system 240, and crawl session service system 234 and/or crawl actor 236 of FIG. 2 may be similar, if not identical, to search utility(ies) 105, host app(s) 110, SERP 135, data store(s) 140, content ingestion system 185, data source(s) 160a-160x, connector 150 or 150a-150x, admin UX 145, connector catalogue 145a, connector 150 or 150a-150x, and crawling agents 170a-170n, respectively, of system 100 of FIG. 1, and the description of these components of system 100 of FIG. 1 are similarly applicable to the corresponding components of FIG. 2.

Example connector architecture 200 includes a search utility 202, a host app 204, SERP 206, a data store(s) 208, and a content ingestion system 210. Example connector architecture 200 further includes a local data source 214 and agent system 216, both located within customer premises 212. In some cases, the agent system 216 includes orchestrator 218, connector framework 220, connector modules 222, and metadata store 224. Example connector architecture 200 further includes an admin UX 226, a connector catalogue 228, an admin service system 230, a data set actor 232, a crawl session service system 234, a crawl actor 236, a metadata store 238, and a connector execution environment or connector system 240. In some examples, the connector execution environment or connector system 240 includes a connector framework software development kit (“SDK”) 242 and one or more connector modules or devices 244. In examples, the connector framework SDK 242 includes a structured query language (“SQL”) server management studio (“SSMS”) configuration system 242a, a connector factory 242b, a checkpoint handler 242c, an application management service (“AMS”) credentials system 242d, one or more connector handlers 242e, and one or more operation handlers 242f. In some cases, the one or more connector modules or devices 244 include one or more data handlers 244a. In some examples, as denoted by dashed line and arrow denoted “Cloud Services,” SERP 206, data store(s) 208, content ingestion system 210, admin UX 226, connector catalogue 228, admin service system 230, data set actor 232, crawl session service 234, crawl actor 236, metadata store 238, connector execution environment 240, and SaaS sources 246 may be part of the cloud services.

With reference to FIG. 2, in operation, search utility 202 of host app 204 may receive a search query for a query term. In response to receiving the search query, the SERP 206 may search a search index of data store(s) 208 for website content matching the query term, the website content being pre-ingested in the data store using content ingestion system 210. For pre-ingestion of documents associated with website content, the documents being available from local data sources located in customer premises 212, agent system 216—using orchestrator 218, connector framework 220, and connector modules 222—may access data associated with the documents from local data source 214 and/or metadata store 224, and such data may be processed as web documents for the website content. The web documents and/or website content may be pre-ingested by the content ingestion system 210 in a manner that is indexable, searchable, refinable, and retrievable prior to receiving the search query.

For pre-ingestion of website content available from third party sources (or shared network environments), admin UX 226 may provide an administrator with options and tools for accessing a connector catalogue 228 to identify and/or to select one or more connectors (e.g., connectors 150 and 150a-150x of FIG. 1) for connecting with data sources (e.g., data source(s) 160a-160x of FIG. 1). In response to identifying and/or selecting the one or more connectors, the admin UX 226 may cause admin service system 230 to instruct data set actor 232 to register a data set and/or to initiate a full or incremental crawl session using crawl session service system 234. In examples, crawl session service system 234 may create a crawl of data sources, which may cause a crawl actor 236 to evaluate a query via connector execution environment 240 and via software as a service (“SaaS”) sources 246. Alternatively or additionally, crawl session service system 234 may access metadata store 238 (in some cases, via connector execution environment 240). In some examples, SSMS configuration system 242a manages configurations of SQL servers or other data sources (e.g., data source(s) 160a-160x). In examples, connector factor 242b creates or modifies connectors for connecting with the SQL servers or other data sources. Checkpoint handler 242c handles checkpoint connections with the SQL servers or other data sources. AMS credentials system 242d manages credentials of apps. Connector handlers 242e and operation handlers 242f handle the connectors and operations of the connectors, respectively, with the SQL servers or other data sources. Data handlers 244a of connector modules 244 handle data using the connector framework SDK components 242a-242f to provide content ingestion (via content ingestion system 210), including putting or adding, patching or modifying, and/or deleting website content and/or web documents for website content. In FIG. 2, the arrow between the connector execution environment 240 and the content ingestion system 210 denotes content ingestion of website content and/or web documents for website content from data sources in a shared network environment(s) (e.g., data source(s) 160a-160x of FIG. 1). The arrows between the connector execution environment 240 and the content ingestion system 210, via SaaS sources 246, denote content ingestion of data items from third party data sources (e.g., data sources 160a-160x of FIG. 1).

FIGS. 3A-3D depict diagrams illustrating various example UXs 300A, 300B, 300C, and 300D for search utilities of host apps when implementing a universal search indexer for enterprise and cloud accessible websites and/or SERP functionality.

In the non-limiting example UX 300A of FIG. 3A, UX 300A includes an admin UX including a header portion 305, a management status tracking section 310, a page header portion 315, a URL entry field 320, and an options field 325. In examples, the header portion 305 includes a file path including a search and intelligence directory, a data sources sub-directory, and an “add new ‘Enterprise websites’ connector” file or page. The data sources of the data sources sub-directory may correspond to data sources 160a-160x with which connectors (e.g., connectors 150 and 150a-150x, including the new Enterprise websites connector) may be connected. In some cases, the management status tracking section 310 includes a list of steps within a process for managing admin functionalities for implementing the universal search indexer for enterprise websites. In some examples, the list of steps within the process includes naming the connection, managing connection settings (which is selected, as shown in the page header portion 315), managing meta tags settings, managing custom property setup, adding URLs to exclude, assigning property labels, managing schema, managing search permissions, refreshing settings, reviewing connection, and completing the process. In examples, the URL entry field 320 includes a field for an administrator to enter one or more URLs corresponding to one or more target websites (e.g., “https://www.testurl.com/test-search”). Options field 325 includes one or more selection fields each including a checkbox, a checklist, a toggle switch, or a radio button. In some examples, the options field 325 includes a field for selecting whether to crawl only websites or webpages listed in the sitemap for the listed one or more URLs or to perform a full crawl of the target websites. In some cases, the options field 325 further includes a field for selecting whether to enable a crawl for dynamic websites or webpages, or whether to enable a crawl for static websites or webpages. In some instances, the options field 325 further includes a field for selecting either a crawl mode for a cloud accessible website or a crawl mode for an enterprise website or an agent of the enterprise website. In some cases, the options field 325 further includes a field for selecting an authentication scheme (e.g., basic authentication that requires password to be transmitted, digest authentication that does not require a password to be transmitted, or new technology local area network (“LAN”) manager (“NTLM”) authentication that authenticates users' identity and protects integrity and confidentiality of user activities). In some examples, although not shown, the admin UX may provide options to generate new schema properties from existing crawl properties with regular expressions without need for administrators to write any code.

FIGS. 3B-3D depict UXs 300B-300D for SERPs. In example UX 300B of FIG. 3B, UI 330 includes a search field 335, a search vertical or scopes list portion 340, an account portion 345, a best match portion 350, and a search results display field 355. A vertical, as used herein, refers to a focused view of a content type that has a tab in the menu navigation. A vertical allows users to narrow down the focus results sets. A scope, as used herein, refers to permissions or delegated permissions for a given resource that represents what a client application can access on behalf of a user. Content from a vertical or scope may be filtered by selection of search verticals 325, which may include at least one of All, Work, Apps, Documents, Web, and More. Selection of the “All” search vertical causes display of all search results for the query term (in this case, “support kb test”). Selection of the “Work” search vertical causes display of work documents or work-related websites or webpages associated with the query term. Selection of the “Apps” search vertical causes display of software applications or apps associated with the query term as found in websites or webpages. Selection of the “Documents” search vertical causes display of documents associated with the query term as found in websites or webpages. Selection of the “Web” search vertical causes display of websites or webpages associated with the query term. Selection of the “More” search vertical causes display of additional search verticals or scopes (e.g., Images, Videos, Maps, News, and/or Shop). The account portion 345 includes a logo portion for the SERP, a user icon, and a menu icon. The user icon includes options for displaying user settings. The menu icon includes options for displaying SERP results. The best match portion 350 includes a portion that lists one or more best-match results that may be selected for display of corresponding search results in the search results display field 355, which displays a listing of search results with links for accessing the webpages, websites, or documents associated with the query term, a summary of each search result, and/or last modified dates.

In example UX 300C of FIG. 3C, UI 360 includes a search field 365, a search vertical or scopes list portion 370, and a search results display field 375. In example UX 300D of FIG. 3D, UI 380 includes a search field 385, a search vertical or scopes list portion 390, and a search results display field 395. The UIs 360 and 380 are similar to UI 330, the UIs 330, 360, and 380 being UIs for different SERPs. The search fields 365 or 385 are similar to search field 335 of UX 300B. The search vertical or scopes list portions 370 or 390 are similar to search vertical or scopes list portion 340. In examples, the search vertical or scopes list portion 370 or 390 may be filtered by selection of search verticals or scopes, which may include at least one of All, People, Sites, Files, Messages, Images, Videos, Data Visualization, Resource Planning, Learning, Wikis, and/or Other Corp Sites. Selection of the “People” search vertical causes display of one or more persons associated with the query term, as found in websites or webpages. Selection of the “Sites” search vertical causes display of websites associated with the query term. Selection of the “Files” search vertical causes display of document files associated with the query term, as found in websites or webpages. Selection of the “Messages” search vertical causes display of one or more communication messages (e.g., email or text messages) associated with the query term, as found in websites or webpages. Selection of the “Images” or “Videos” search vertical causes display of images or videos associated with the query term, as found in websites or webpages. Selection of the “Data Visualization” search vertical causes display of search results associated with the query term, as found in an interactive data visualization software product. Selection of the “Resource Planning” search vertical causes display of search results associated with the query term, as found in a resource planning and customer relationship management intelligent business application. Selection of the “Learning” search vertical causes display of learning documents associated with the query term, as found in websites or webpages. Selection of the “Wikis” search vertical causes display of encyclopedic data associated with the query term, as found in websites or webpages. Selection of the “Other Corp Sites” search vertical causes display of websites associated with the query term. The search results display field 375 or 395 may include display of a logo for the corresponding SERP (e.g., Logo1 for the SERP of UI 360, Logo2 for the SERP of UI 380), a listing of search results with links for accessing the webpages, websites, or documents associated with the query term, a summary of each search result, and/or last modified dates.

In examples, search results from all connected external enterprise data sources are displayed as rich adaptive cards in UIs of SERPs. The universal search indexer enables, via admin UXs, configuration of data sources to crawl their data repositories and enable users to search for content in the search utility. Search results in the UIs include enterprise website content that are extracted and ingested from enterprise websites behind firewalls. An administrator configures connectors in the admin UX to ingest data from custom enterprise data sources (e.g., Intranet, data lake storage, comma-separated value (“CSV”) data sources). In some cases, the administrator configures display layout for search results from connector to be used when surfacing search results to user. The UI of the SERP receives the search query from a user, who may be different from the administrator. The SERP, using logged-in user information, fetches work results (e.g., results including website and/or web document results) in response to the search query. Using NL processing (e.g., using NL processor 175 of FIG. 1), the search query server determines whether the search query has connector intent, as described herein. Search results from the connector are configured by the administrator are surfaced or displayed directly in the UI of the SERP (e.g., a search box).

FIGS. 4A-4C depict an example method 400 for implementing a universal search indexer for enterprise and cloud accessible websites. Method 400 of FIG. 4A continues onto FIG. 4B following the circular marker denoted, “C,” or continues onto FIG. 4C following the circular marker denoted, “D.” Method 400 of FIG. 4C returns to FIG. 4A following the circular marker denoted, “E.”

At operation 405, an admin UX is provided that presents at least one of one or more first options for configuring a plurality of webpages of a target website, one or more second options for configuring one or more crawling agents among a plurality of crawling agents, one or more third options for setting an interval or a schedule for crawling the target website, and/or one or more fourth options for managing custom search schema properties that are extractable from meta tags of the target website. At operation 410, a crawling agent among the one or more crawling agents is used to crawl the target website, in some cases, in response to user input and/or user request to initiate a crawl of the target website. Method 400 either may continue onto the process at operation 415 or may continue onto the process at operation 440, following the circular marker denoted, “A,” thereafter returning to the process at operation 415, following the circular marker denoted, “B.”

At operation 415, as the target website is being crawled (at operation 410), website content is extracted. At operation 420, the extracted website content is ingested within a data store, in some cases, by indexing the extracted website content in a search index of the data store. In some examples, indexing the extracted website content (at operation 420) includes generating a listing within the search index, the listing being generated to be searchable and refinable using a search engine, the extracted website content being retrievable via the search engine. In examples, the ingested extracted website content is configured to be searchable using semantic search functionality. In some examples, semantic search functionality, as used herein, refers to a data search technique that uses intent and/or contextual meaning behind a search query to deliver more relevant results, rather than simply searching based on literal matching of query terms. Method 400 either may continue onto the process at operation 465, following the circular marker denoted, “C,” or may continue onto the process at operation 475, following the circular marker denoted, “D.”

In examples, crawling the target website (at operation 410) includes determining whether a site map is available for the target website (at operation 425). Based on a determination that a site map is available for the target website, the crawling agent is used to crawl the target website based on the site map for the target website (at operation 430). Based on a determination that a site map is not available for the target website, the crawling agent is used to perform a full crawl of the target website (at operation 435). A site map, as used herein, refers to a list or structured list of pages of a website within a domain. In some examples, the site map may have intentionally left unlisted some webpages due to security or privacy reasons, and such webpages are not crawled in accordance with the process of operation 430, but are crawled as part of a full crawl (such as in the process of the operation 435). In some cases, the structured list includes an extensible markup language (“XML”) sitemap, which lists the web pages in a target website, the relative importance of the listed web pages, and how often the listed web pages are updated. In some instances, the structured list includes hypertext markup language (“HTML”) sitemap, which includes formatted links to webpages. In some instances, at operation 440 (following the circular marker denoted, “A”), method 400 includes crawling, using the crawling agent, web documents that are contained within, embedded in, or linked by one or more webpages among the plurality of webpages of the target website. In some cases, crawling the target website and crawling the web documents are performed as part of a single crawl function. In examples, the crawling agent is among a plurality of crawling agents, where crawling the target website and crawling the web documents are performed by the plurality of crawling agents as part of a single set of parallel and coordinated crawl functions in which crawling the target website is performed by two or more crawling agents in parallel and crawling the web documents is concurrently performed by two or more other crawling agents in parallel. In examples, incremental synchronization support is implemented for sitemap-enabled crawls (not shown) that incrementally synchronizes ingestion during crawling of the target website and/or web documents. Method 400 returns to the process at operation 415.

In some examples, extracting website content (at operation 415) includes extracting a meta tag from a webpage among the plurality of webpages of the target website (at operation 445), the meta tag containing metadata including information regarding the webpage. Alternatively or additionally, extracting website content (at operation 415) includes determining whether the website content has changed (at operation 450). In some examples, determining whether the website content has changed (at operation 450) includes comparing date-time modified timestamps of one or more webpages among the plurality of webpages of the target website with date-time saved timestamps of previously saved website content for the one or more webpages. If the data-time modified timestamps indicate that the one or more webpages is after the date-time saved timestamps of the one or more webpages, then the website content is considered to have been changed. Based on a determination that the website content has changed, updated website content that corresponds to changes in the website content is extracted (at operation 455), and ingesting the extracted website content (at operation 420) includes ingesting the extracted updated website content within the data store (at operation 460). Based on a determination that the website content has not changed, method 400 either continues onto the process at operation 465 in FIG. 4B, following the circular marker denoted, “C,” or continues onto the process at operation 475 in FIG. 4C, following the circular marker denoted, “D.”

At operation 465 in FIG. 4B (following the circular marker denoted, “A,” in FIG. 4A), method 400 includes identifying, using an annotation parser, which portions of the extracted website content from a webpage among the plurality of webpages of the target website correspond to which portions of the webpage from which they are extracted. The portions of the webpage includes a header portion, a footer portion, and a body. At operation 470, method 400 includes annotating, using the annotation parser, each portion of the extracted website content with annotations indicating one of the header portion, the footer portion, or the body, based on the identification.

At operation 475 in FIG. 4C (following the circular marker denoted, “B,” in FIG. 4C), method 400 includes receiving a search query for a query term via the search engine. At operation 480, method 400 includes searching the search index of the data store for a target content (e.g., website content corresponding to the query term). At operation 485, determining whether the search index contains a listing of the website content corresponding to the query term. Based on a determination that the search index contains a listing of the website content corresponding to the query term, method 400 includes generating search results based on matching website content and presenting the search results within a UI of a SERP. The search results include a link to the target content based on the listing within the search index, the target content being retrievable by following the link. Based on a determination that the search index does not contain a listing of the website content corresponding to the query term, method 400 returns to the process at operation 410 following the circular marker denoted, “E.”

While the techniques and procedures in method 400 are depicted and/or described in a certain order for purposes of illustration, it should be appreciated that certain procedures may be reordered and/or omitted within the scope of various embodiments. Moreover, while the method 400 may be implemented by or with (and, in some cases, are described below with respect to) the systems, examples, or embodiments 100, 200, 300A, 300B, 300C, and 300D of FIGS. 1, 2, 3A, 3B, 3C, and 3D, respectively (or components thereof), such methods may also be implemented using any suitable hardware (or software) implementation. Similarly, while each of the systems, examples, or embodiments 100, 200, 300A, 300B, 300C, and 300D of FIGS. 1, 2, 3A, 3B, 3C, and 3D, respectively (or components thereof), can operate according to the method 400 (e.g., by executing instructions embodied on a computer readable medium), the systems, examples, or embodiments 100, 200, 300A, 300B, 300C, and 300D of FIGS. 1, 2, 3A, 3B, 3C, and 3D can each also operate according to other modes of operation and/or perform other suitable procedures.

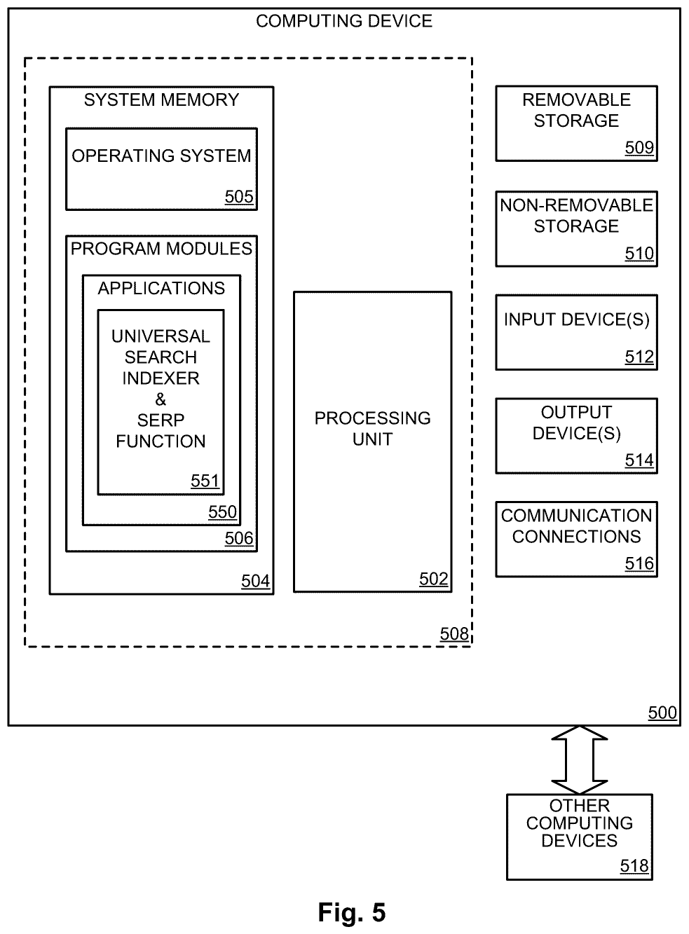

FIG. 5 depicts a block diagram illustrating physical components (i.e., hardware) of a computing device 500 with which examples of the present disclosure may be practiced. The computing device components described below may be suitable for a client device implementing the universal search indexer for enterprise and cloud accessible websites, as discussed above. In a basic configuration, the computing device 500 may include at least one processing unit 502 and a system memory 504. The processing unit(s) (e.g., processors) may be referred to as a processing system. Depending on the configuration and type of computing device, the system memory 504 may include volatile storage (e.g., random access memory), non-volatile storage (e.g., read-only memory), flash memory, or any combination of such memories. The system memory 504 may include an operating system 505 and one or more program modules 506 suitable for running software applications 550, such as universal search indexer and SERP function 551, to implement one or more of the systems or methods described above.

The operating system 505, for example, may be suitable for controlling the operation of the computing device 500. Furthermore, aspects of the invention may be practiced in conjunction with a graphics library, other operating systems, or any other application program and is not limited to any particular application or system. This basic configuration is illustrated in FIG. 5 by those components within a dashed line 508. The computing device 500 may have additional features or functionalities. For example, the computing device 500 may also include additional data storage devices (which may be removable and/or non-removable), such as, for example, magnetic disks, optical disks, or tape. Such additional storage is illustrated in FIG. 5 by a removable storage device(s) 509 and a non-removable storage device(s) 510.

As stated above, a number of program modules and data files may be stored in the system memory 504. While executing on the processing unit 502, the program modules 506 may perform processes including one or more of the operations of the method(s) as illustrated in FIGS. 4A and 4B, or one or more operations of the system(s) and/or apparatus(es) as described with respect to FIGS. 1-3, or the like. Other program modules that may be used in accordance with examples of the present disclosure may include applications such as electronic mail and contacts applications, word processing applications, spreadsheet applications, database applications, slide presentation applications, drawing or computer-aided application programs, artificial intelligence (“AI”) applications and machine learning (“ML”) modules on cloud-based systems, etc.

Furthermore, examples of the present disclosure may be practiced in an electrical circuit including discrete electronic elements, packaged or integrated electronic chips containing logic gates, a circuit utilizing a microprocessor, or on a single chip containing electronic elements or microprocessors. For example, examples of the present disclosure may be practiced via a system-on-a-chip (“SOC”) where each or many of the components illustrated in FIG. 5 may be integrated onto a single integrated circuit. Such an SOC device may include one or more processing units, graphics units, communications units, system virtualization units and various application functionalities all of which may be integrated (or “burned”) onto the chip substrate as a single integrated circuit. When operating via an SOC, the functionality, described herein, with respect to generating suggested queries, may be operated via application-specific logic integrated with other components of the computing device 500 on the single integrated circuit (or chip). Examples of the present disclosure may also be practiced using other technologies capable of performing logical operations such as, for example, AND, OR, and NOT, including, but not limited to, mechanical, optical, fluidic, and/or quantum technologies.

The computing device 500 may also have one or more input devices 512 such as a keyboard, a mouse, a pen, a sound input device, and/or a touch input device, etc. The output device(s) 514 such as a display, speakers, and/or a printer, etc. may also be included. The aforementioned devices are examples and others may be used. The computing device 500 may include one or more communication connections 516 allowing communications with other computing devices 518. Examples of suitable communication connections 516 include, but are not limited to, radio frequency (“RF”) transmitter, receiver, and/or transceiver circuitry; universal serial bus (“USB”), parallel, and/or serial ports; and/or the like.

The term “computer readable media” as used herein may include computer storage media. Computer storage media may include volatile and nonvolatile, and/or removable and non-removable, media that may be implemented in any method or technology for storage of information, such as computer readable instructions, data structures, or program modules. The system memory 504, the removable storage device 509, and the non-removable storage device 510 are all computer storage media examples (i.e., memory storage). Computer storage media may include random access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media may be non-transitory and tangible, and computer storage media do not include a carrier wave or other propagated data signal.

Communication media may be embodied by computer readable instructions, data structures, program modules, or other data in a modulated data signal, such as a carrier wave or other transport mechanism, and may include any information delivery media. The term “modulated data signal” may describe a signal that has one or more characteristics that are set or changed in such a manner as to encode information in the signal. By way of example, and not limitation, communication media may include wired media such as a wired network or direct-wired connection, and wireless media such as acoustic, RF, infrared, and other wireless media.

As should be appreciated from the foregoing, the present technology provides multiple technical benefits and solutions to technical problems. For instance, implementing a universal search indexer for enterprise and cloud accessible websites generally raises multiple technical problems. For example, one technical problem includes web searches of enterprise websites being typically blocked by the firewalls behind which the enterprise websites are located. The present technology provides a system that implements universal search indexing for enterprise websites behind firewalls and cloud accessible websites. The enterprise websites and the cloud accessible websites can be static or dynamic websites. A universal search indexer, using a crawling agent, crawls a target website and/or web documents that are contained within, embedded in, or linked by one or more webpages among the plurality of webpages of the target website. The universal search indexer extracts website content and/or web documents as the target website is being crawled, and ingests the extracted website content and/or web documents within a data store, by indexing the extracted website content and/or web document in a search index of the data store in a manner that is searchable, refinable, and retrievable.

In an aspect, the technology relates to a system, including a processing system and memory coupled to the processing system. The memory including computer executable instructions that, when executed by the processing system, causes the system to perform operations including crawling, using a crawling agent, a target website. The target website is an enterprise website that is accessible via a firewall. The target website includes a plurality of webpages including at least one of one or more static webpages or one or more dynamic webpages. The operations further include extracting website content as the target website is being crawled; and ingesting the extracted website content within a data store, by indexing the extracted website content in a search index of the data store. Indexing the extracted website content includes generating a listing within the search index, the listing being generated to be searchable and refinable using a search engine, the extracted website content being retrievable via the search engine.

In some examples, crawling the target website includes determining whether a site map is available for the target website; and, based on a determination that a site map is available for the target website, crawling, using the crawling agent, the target website based on the site map for the target website. In some instances, the operations further include extracting a meta tag from a webpage among the plurality of webpages of the target website, the meta tag containing metadata including information regarding the webpage.

In examples, the operations further include crawling, using the crawling agent, web documents that are contained within, embedded in, or linked by one or more webpages among the plurality of webpages of the target website. In some cases, crawling the target website and crawling the web documents are performed as part of a single crawl function. In some instances, the crawling agent is among a plurality of crawling agents. Crawling the target website and crawling the web documents are performed by the plurality of crawling agents as part of a single set of parallel and coordinated crawl functions in which crawling the target website is performed by two or more crawling agents in parallel. Crawling the web documents is concurrently performed by two or more other crawling agents in parallel. In some cases, the web documents each includes one of a word processor document file, a spreadsheet document file, a presentation document file, a drawing document file, a printable format document file, an email data file, a calendar data file, a database item document file, a web document file, an image file, or a video file.

In some examples, extracting the website content includes determining whether the website content has changed; and, based on a determination that the website content has changed, extracting updated website content that corresponds to changes in the website content. Ingesting the extracted website content includes ingesting the extracted updated website content within the data store. In some cases, determining whether the website content has changed includes comparing date-time modified timestamps of one or more webpages among the plurality of webpages of the target website with date-time saved timestamps of previously saved website content for the one or more webpages.

In examples, the operations further include providing an admin UX, the admin UX presents at least one of one or more first options for configuring the plurality of webpages, one or more second options for configuring the crawling agent, one or more third options for setting an interval or a schedule for crawling the target website, or one or more fourth options for managing custom search schema properties that are extractable from meta tags of the target website. In some cases, the operations further include identifying, using an annotation parser, which portions of the extracted website content from a webpage among the plurality of webpages of the target website correspond to which portions of the webpage from which they are extracted, the portions of the webpage including a header portion, a footer portion, and a body. The operations further include annotating, using the annotation parser, each portion of the extracted website content with annotations indicating one of the header portion, the footer portion, or the body, based on the identification.

In some examples, the operations further include incrementally synchronizing ingestion of the extracted website content during crawling of the target website. In examples, ingestion of the extracted website content is performed prior to receiving a search query via the search engine. In some cases, the ingested extracted website content is configured to be searchable using semantic search functionality. In some instances, the operations further include, in response to receiving a search query via the search engine, searching the search index of the data store for a target content. The operations further include generating search results and presenting the search results within a UI of a SERP, the search results including a link to the target content based on the listing within the search index, the target content being retrievable by following the link.

In another aspect, the technology relates to a computer-implemented method. The computer-implemented method includes providing an admin UX, the admin UX presenting at least one of one or more first options for configuring a plurality of webpages of a target website, one or more second options for configuring one or more crawling agents among a plurality of crawling agents, one or more third options for setting an interval or a schedule for crawling the target website, or one or more fourth options for managing custom search schema properties that are extractable from meta tags of the target website. The target website is an enterprise website that is accessible via a firewall. The computer-implemented method includes, based on a determination that a site map is available for the target website, crawling, using the one or more crawling agents, the target website and web documents that are contained within, embedded in, or linked by one or more webpages among the plurality of webpages of the target website. In some examples, crawling is based on the site map for the target website and based on the at least one of the one or more first options, the one or more second options, the one or more third options, or the one or more fourth options. The plurality of webpages includes at least one of one or more static webpages or one or more dynamic webpages. The computer-implemented method further includes extracting website content as the target website is being crawled; and ingesting the extracted website content within a data store, by indexing the extracted website content in a search index of the data store. Indexing the extracted website content includes generating a listing within the search index, the listing being generated to be searchable and refinable using a search engine, the extracted website content being retrievable via the search engine.

In some examples, extracting the website content includes determining whether the website content has changed; and, based on a determination that the website content has changed, extracting updated website content that corresponds to changes in the website content. Ingesting the extracted website content includes ingesting the extracted updated website content within the data store.

In yet another aspect, the technology relates to a system including a processing system and memory coupled to the processing system. The memory includes computer executable instructions that, when executed by the processing system, causes the system to perform operations including, in response to receiving a search query for a query term, searching a search index of a data store for website content corresponding to the query term. The website content is associated with an enterprise website that is accessible via a firewall, and is pre-ingested in the data store in a manner that is indexable, searchable, refinable, and retrievable prior to receiving the search query. The operations further include, based on a determination that the search index contains a listing of the website content corresponding to the query term, generating search results based on matching website content and presenting the search results within a UI of a SERP, based on configurations of display layout within the UI depending on connectors through which the matching website content were extracted for pre-ingestion. The configurations of display layout within the UI are pre-defined by an admin via an admin UX.

In examples, the operations further include providing an admin UX, the admin UX presenting at least one of one or more first options for configuring one or more connectors to ingest data from corresponding one or more data sources, or one or more second options for configuring the display layout within the UI for search results from the one or more connectors. In some examples, the operations further include, based on a determination, using NL processing, that the search query has connector intent, generating consolidated search results including matching website content from two or more different data sources via corresponding two or more connectors, and presenting the consolidated search results within the UI of the SERP. Presenting the consolidated search results is based on one of common configurations of display layout within the UI for the two or more connectors or configurations for display layout within the UI based on a hierarchy for the two or more connectors.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. For denoting a plurality of components, the suffixes “a” through “n” may be used, where n denotes any suitable integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

In this detailed description, for the purposes of explanation, numerous specific details are set forth to provide a thorough understanding of the described embodiments. It will be apparent to one skilled in the art, however, that other embodiments of the present invention may be practiced without some of these specific details. In other instances, certain structures and devices are shown in block diagram form. While aspects of the technology may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the detailed description does not limit the technology, but instead, the proper scope of the technology is defined by the appended claims. Examples may take the form of a hardware implementation, or an entirely software implementation, or an implementation combining software and hardware aspects. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features. The detailed description is, therefore, not to be taken in a limiting sense.

Aspects of the present invention, for example, are described above with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase “at least one of element A, element B, or element C” (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

What is claimed is:

1. A system, comprising:
a processing system; and
memory coupled to the processing system, the memory comprising computer executable instructions that, when executed by the processing system, causes the system to perform operations comprising:
crawling, using a crawling agent, a target website, the target website being an enterprise website that is accessible via a firewall, the target website comprising a plurality of webpages including at least one of one or more static webpages or one or more dynamic webpages;
extracting website content as the target website is being crawled; and
ingesting the extracted website content within a data store, by indexing the extracted website content in a search index of the data store,
wherein indexing the extracted website content comprises generating a listing within the search index, the listing being generated to be searchable and refinable using a search engine, the extracted website content being retrievable via the search engine.

2. The system of claim 1, wherein crawling the target website comprises:
determining whether a site map is available for the target website; and
based on a determination that a site map is available for the target website, crawling, using the crawling agent, the target website based on the site map for the target website.

3. The system of claim 1, wherein the operations further comprise:
extracting a meta tag from a webpage among the plurality of webpages of the target website, the meta tag containing metadata comprising information regarding the webpage.

4. The system of claim 1, wherein the operations further comprise:
crawling, using the crawling agent, web documents that are contained within, embedded in, or linked by one or more webpages among the plurality of webpages of the target website.

5. The system of claim 4, wherein crawling the target website and crawling the web documents are performed as part of a single crawl function.

6. The system of claim 4, wherein the crawling agent is among a plurality of crawling agents, wherein crawling the target website and crawling the web documents are performed by the plurality of crawling agents as part of a single set of parallel and coordinated crawl functions in which crawling the target website is performed by two or more crawling agents in parallel and crawling the web documents is concurrently performed by two or more other crawling agents in parallel.

7. The system of claim 4, wherein the web documents each comprises one of a word processor document file, a spreadsheet document file, a presentation document file, a drawing document file, a printable format document file, an email data file, a calendar data file, a database item document file, a web document file, an image file, or a video file.

8. The system of claim 1, wherein extracting the website content comprises:
determining whether the website content has changed; and
based on a determination that the website content has changed, extracting updated website content that corresponds to changes in the website content,
wherein ingesting the extracted website content comprises ingesting the extracted updated website content within the data store.

9. The system of claim 8, wherein determining whether the website content has changed comprises comparing date-time modified timestamps of one or more webpages among the plurality of webpages of the target website with date-time saved timestamps of previously saved website content for the one or more webpages.

10. The system of claim 1, wherein the operations further comprise:
providing an administrator (“admin”) user experience (“UX”), the admin UX presents at least one of one or more first options for configuring the plurality of webpages, one or more second options for configuring the crawling agent, one or more third options for setting an interval or a schedule for crawling the target website, or one or more fourth options for managing custom search schema properties that are extractable from meta tags of the target website.

11. The system of claim 1, wherein the operations further comprise:
identifying, using an annotation parser, which portions of the extracted website content from a webpage among the plurality of webpages of the target website correspond to which portions of the webpage from which they are extracted, the portions of the webpage comprising a header portion, a footer portion, and a body; and
annotating, using the annotation parser, each portion of the extracted website content with annotations indicating one of the header portion, the footer portion, or the body, based on the identification.

12. The system of claim 1, wherein the operations further comprise:
incrementally synchronizing ingestion of the extracted website content during crawling of the target website.

13. The system of claim 1, wherein ingestion of the extracted website content is performed prior to receiving a search query via the search engine.

14. The system of claim 1, wherein the ingested extracted website content is configured to be searchable using semantic search functionality.

15. The system of claim 1, wherein the operations further comprise:
in response to receiving a search query via the search engine, searching the search index of the data store for a target content; and
generating search results and presenting the search results within a user interface (“UI”) of a search engine results page (“SERP”), the search results comprising a link to the target content based on the listing within the search index, the target content being retrievable by following the link.

16. A computer-implemented method, comprising:
providing an administrator (“admin”) user experience (“UX”), the admin UX presenting at least one of one or more first options for configuring a plurality of webpages of a target website, one or more second options for configuring one or more crawling agents among a plurality of crawling agents, one or more third options for setting an interval or a schedule for crawling the target website, or one or more fourth options for managing custom search schema properties that are extractable from meta tags of the target website, the target website being an enterprise website that is accessible via a firewall;
based on a determination that a site map is available for the target website, crawling, using the one or more crawling agents, the target website and web documents that are contained within, embedded in, or linked by one or more webpages among the plurality of webpages of the target website, based on the site map for the target website and based on the at least one of the one or more first options, the one or more second options, the one or more third options, or the one or more fourth options, the plurality of webpages including at least one of one or more static webpages or one or more dynamic webpages;
extracting website content as the target website is being crawled; and
ingesting the extracted website content within a data store, by indexing the extracted website content in a search index of the data store,
wherein indexing the extracted website content comprises generating a listing within the search index, the listing being generated to be searchable and refinable using a search engine, the extracted website content being retrievable via the search engine.

17. The computer-implemented method of claim 16, wherein extracting the website content comprises:
determining whether the website content has changed; and
based on a determination that the website content has changed, extracting updated website content that corresponds to changes in the website content,
wherein ingesting the extracted website content comprises ingesting the extracted updated website content within the data store.

18. A system, comprising:
a processing system; and
memory coupled to the processing system, the memory comprising computer executable instructions that, when executed by the processing system, causes the system to perform operations comprising:
in response to receiving a search query for a query term, searching a search index of a data store for website content corresponding to the query term, the website content being associated with an enterprise website that is accessible via a firewall, the website content being pre-ingested in the data store in a manner that is indexable, searchable, refinable, and retrievable prior to receiving the search query;
based on a determination that the search index contains a listing of the website content corresponding to the query term, generating search results based on matching website content and presenting the search results within a user interface (“UI”) of a search engine results page (“SERP”), based on configurations of display layout within the UI depending on connectors through which the matching website content were extracted for pre-ingestion, the configurations of display layout within the UI being pre-defined by an administrator (“admin”) via an admin UX.

19. The system of claim 18, wherein the operations further comprise:
providing an administrator (“admin”) user experience (“UX”), the admin UX presenting at least one of one or more first options for configuring one or more connectors to ingest data from corresponding one or more data sources, or one or more second options for configuring the display layout within the UI for search results from the one or more connectors.

20. The system of claim 18, wherein the operations further comprise:
based on a determination, using natural language (“NL”) processing, that the search query has connector intent, generating consolidated search results including matching website content from two or more different data sources via corresponding two or more connectors, and presenting the consolidated search results within the UI of the SERP, based on one of common configurations of display layout within the UI for the two or more connectors or configurations for display layout within the UI based on a hierarchy for the two or more connectors.
